(19) United States
(12) Patent Application Publication
(10) Pub. No.: US 2025/0223103 A1
(43) Pub. Date: Jul. 10, 2025

(54) VALET PARKING SYSTEM, AND METHOD FOR VALET PARKING AND PICKUP OF VEHICLE

(71) Applicant: HL ROBOTICS CO., LTD., Gyeonggi-do (KR)

(72) Inventors: Minhye YU, Gyeonggi-do (KR); SeongHo CHOI, Gyeonggi-do (KR); Joon-Kyu SONG, Gyeonggi-do (KR); Jeongjae PARK, Gyeonggi-do (KR); Junha SOHN, Gyeonggi-do (KR); Dongseon KIM, Gyeonggi-do (KR); Oseok KWON, Gyeonggi-do (KR); Mingeun PARK, Gyeonggi-do (KR); Byungyong KANG, Gyeonggi-do (KR)

(21) Appl. No.: 19/009,776

(22) Filed: Jan. 3, 2025

(30) Foreign Application Priority Data
Jan. 4, 2024 (KR) 10-2024-0001604

(51) Int. Cl. B65G 1/04; E04H 6/22; G08G 1/14

(52) U.S. Cl. CPC B65G 1/04; E04H 6/22; G08G 1/148

(57) ABSTRACT

A valet parking system includes at least one first vehicle transfer robot located in a vehicle stop zone where a vehicle for valet parking is stopped and configured to move the vehicle stopped in the vehicle stop zone; at least one vehicle transfer pallet configured to load the vehicle moved by the first vehicle transfer robot; a vehicle transfer rail installed from the vehicle stop zone to a vehicle parking zone; at least one second vehicle transfer robot located in the vehicle parking zone and configured to move the vehicle transported by the vehicle transfer pallet to a vehicle parking position in the vehicle parking zone, or moving a vehicle parked in the vehicle parking position back to the vehicle transfer pallet; and a server for controlling the first vehicle transfer robot, the vehicle transfer pallet, and the second vehicle transfer robot.

### CROSS-REFERENCE TO RELATED APPLICATION

This application claims priority to and the benefit of Korean Patent Application No. 10-2024-0001604, filed on Jan. 4, 2024, the disclosure of which is incorporated herein by reference in its entirety.

### BACKGROUND

### 1. Technical Field

The present disclosure generally relates to a valet parking system, a method for valet parking and pickup of a vehicle, and more particularly, to an airport valet parking system, a valet vehicle parking method and a valet vehicle pickup method using a vehicle transfer robot and a vehicle transfer rail.

### 2. Discussion of Related Art

Inside or around an airport, a flat parking lot is built to park vehicles of airport visitors. In the airports with many visitors, a sufficient amount of parking zone is secured by securing vast parking lot land.

Since the parking zone in the airport is very large, drivers using the airport need to find empty parking spaces in the airport parking zone, remember the location of a specific parking space where a vehicle is parked, and take a lot of luggage from the vehicle from the parked location and transport it by themselves to use the terminal in the airport.

Users visiting the airport normally plan to park and move in the airport parking lot with sufficient time in consideration of parking and travel time in the airport. However, sometimes, it may be necessary for drivers who lack time to park vehicles or travel in the airport to use a valet parking service of valet parking a vehicle in the airport.

A conventional valet parking method is operated in a method that a valet service provider who can drive for a valet customer receives a car key from the valet customer to park a vehicle, issues a vehicle parking ticket, and then drive the vehicle from a valet stop zone to a parking zone. After that, the valet customer who wants to pick up the vehicle can show the vehicle parking ticket to the valet service provider who performed the valet parking on behalf of the valet customer and then pick up the valet parked vehicle.

However, such a conventional method for a proxy driver to drive a vehicle directly and park a valet vehicle in a parking zone may be efficient within a small area of parking space. However, if a valet parking service is provided in a large and complex area, such as a parking lot in an airport, it may take a long time for a driver of a valet service provider to park the valet vehicle on behalf of the valet customer, and if there are many valet customers at once, it may take more time for valet parking.

In addition, in the case of parking lots in the airport, parking periods vary from a short period of a day or two to a long period of a week or a month, so efficient management for parking spaces is necessary.

Meanwhile, recently, a vehicle transfer robot capable of moving a vehicle in a parking lot has been developed. When parking or moving a vehicle within a narrow parking lot using such a vehicle transfer robot, there is no need for people to park, so it has the advantage of being able to park or move the vehicle conveniently. There is need to develop a system for vehicle valet parking and a method for vehicle valet parking in a wide place such as an airport using such a vehicle transfer robot.

### SUMMARY

The present disclosure is to solve the above problems, and some exemplary embodiments of the present disclosure may be related to a valet parking system and method capable of parking a driver's vehicle in a vehicle parking zone by proxy in a large facility such as an airport.

Certain exemplary embodiments of the present disclosure may be also related to a valet parking system and method capable of automatically parking a vehicle in a vehicle parking zone using a vehicle transfer robot and a vehicle transfer pallet in a large facility such as an airport.

Some exemplary embodiments of the present disclosure may be also related to a valet parking system and method capable of efficiently operating a parking zone in a large facility such as an airport.

Certain exemplary embodiments of the present disclosure may be also related to a method for providing in-airport vehicle pickup service in which a driver can automatically pick up a vehicle parked in a vehicle parking zone in an airport.

The objects of the present disclosure are not limited to the above-described objects, and other objects that are not mentioned will be able to be clearly understood by those skilled in the art to which the present disclosure pertains from the following description.

According to an aspect of the present disclosure, a valet parking system for valet parking a vehicle entering an airport in a vehicle parking zone includes at least one first vehicle transfer robot placed in a vehicle stop zone where a vehicle requiring valet parking is stopped and configured to move the vehicle stopped in the vehicle stopping zone; at least one vehicle transfer pallet on which the vehicle moved by the first vehicle transfer robot can be loaded; a vehicle transfer rail installed from the vehicle stop zone to the vehicle parking zone so that the vehicle transfer pallet can be moved to the vehicle parking zone; at least one second vehicle transfer robot placed in the vehicle parking zone for moving the vehicle transported by the vehicle transfer pallet to a vehicle parking position in the vehicle parking zone, or moving a parked vehicle located in the vehicle parking position back to the vehicle transfer pallet; and a server for controlling the first vehicle transfer robot, the vehicle transfer pallet, and the second vehicle transfer robot.

In this case, the vehicle stop zone may include a driver drop-off zone where a vehicle entering the airport and requiring valet parking stops and a driver gets off; and a driver riding zone for a driver to ride a vehicle transported from the vehicle parking zone.

In this case, the vehicle parking zone may include a first vehicle parking zone where a long-term parked vehicle parked for a predetermined period of time or more is parked; and a second vehicle parking zone where a short-term parked vehicle parked for a predetermined period of time or less is parked.

In this case, each of the first vehicle parking zone and the second vehicle parking zone may be divided into a first parking area in which some of the at least one second vehicle transfer robot is operated and a second parking area in which the rest of the at least one second vehicle transfer robot is operated, and the first parking area may be located in front of the second parking area in the transfer direction of the vehicle transfer rail.

In this case, the first vehicle parking zone may be located in front of the second vehicle parking zone in the transfer direction of the vehicle transfer rail.

In this case, the vehicle transfer rail may be arranged in the form of an infinite track rail between the vehicle stop zone and the vehicle parking zone.

In this case, the vehicle transfer rail may be arranged to pass through the vehicle parking zone.

In this case, the valet parking system may further include a kiosk placed in the vehicle stop zone, and the kiosk may include an information input device for inputting information about a vehicle stopped in the vehicle stop zone and its driver; a display device for displaying the input vehicle and driver information; and a transceiver for transmitting and receiving the vehicle and driver information to and from the server.

In this case, the server may include a data storage device for storing information about a vehicle parked in the vehicle parking zone and its driver; a parking position calculator for determining which one of a plurality of vehicle parking positions in the vehicle parking zone should be used to park the vehicle placed in the vehicle parking zone; a vehicle transfer robot controller for controlling the first and second vehicle transfer robots to move the vehicle to the vehicle parking position determined by the parking position calculator; a transfer pallet controller for controlling movement of the transfer pallet moving on the vehicle transfer rail; and a transceiver for transmitting and receiving information between the vehicle transfer robot controller and the first and second vehicle transfer robots, and between the transfer pallet controller and the transfer pallet.

In this case, the server may include an input device for inputting commands for controlling the vehicle transfer robot controller and the transfer pallet controller; and a display device that displays control situations of the vehicle transfer robot controller and the transfer pallet controller.

In this case, the valet parking system may further include at least one repeater that relays signals transmitted and received between the server and a first vehicle transfer robot located in the vehicle stop zone or a second vehicle transfer robot located in the vehicle parking zone.

In this case, the server may be: configured to provide a program on the web that can be accessed using a terminal owned by a driver of a vehicle, configured such that the driver of the vehicle can transmit driver and vehicle information of the vehicle to the server through the program, and configured to receive parking information on the vehicle parked in the vehicle parking zone through the program.

In this case, each of the first vehicle transfer robot and the second vehicle transfer robot may include a robot body; two pairs of cantilever-type support members provided on the robot body and capable of lifting the front and rear wheels of the vehicle respectively; a plurality of wheels provided on the robot body; a driving motor for driving the wheel; a power supply that supplies power to the driving motor; and a robot controller for controlling the driving motor.

In this case, the transfer pallet may include a plate-shaped pallet body; a plurality of wheels provided on the pallet body; a drive motor that drives the plurality of wheels; a power supply that supplies power to the driving motor; and a transfer pallet controller for controlling the driving motor.

In this case, the vehicle parking zone may further include a first vehicle temporary parking zone and a second vehicle temporary parking zone, and the first vehicle temporary parking zone may be provided as a zone for temporarily parking a vehicle stopped in the vehicle stop zone and then transferring the temporarily parked vehicle to the first vehicle parking zone, and the second vehicle temporary parking zone may be provided as a zone for temporarily parking a vehicle parked in the second vehicle parking zone before transferring it to the driver riding zone for the driver to ride.

In this case, at least one third vehicle transfer robot and at least one fourth vehicle transfer robot may be disposed in each of the first vehicle temporary parking zone and the second vehicle temporary parking zone.

In this case, a vehicle transfer rail may be installed between the vehicle stop zone and the first vehicle temporary parking zone, between the first vehicle temporary parking zone and the first vehicle parking zone, between the second vehicle parking zone and the second vehicle temporary parking zone, and between the second vehicle temporary parking zone and the vehicle stop zone, respectively.

According to another aspect of the present disclosure, a valet parking method for valet parking a vehicle entering an airport in a vehicle parking zone may include (a) an information providing step of receiving information on a vehicle and a driver wishing to park in the vehicle parking zone from the driver; (b) a vehicle stop checking step of checking the vehicle stopped in a vehicle stop zone; (c) a vehicle transfer step using a vehicle transfer robot to move the vehicle stopped at the vehicle stop zone to a vehicle transfer pallet on a vehicle transfer rail using a first vehicle transfer robot; (d) a vehicle transfer step using a vehicle transfer pallet to move the vehicle to the vehicle parking zone with the vehicle transfer pallet; and (e) a vehicle parking step of moving the vehicle from the vehicle parking zone to a vehicle parking position in the vehicle parking zone using a second vehicle transfer robot.

In this case, in the (e) vehicle parking step, a server may calculate and determine a vehicle parking position where the vehicle should be parked, and guide the second vehicle transfer robot to park the vehicle at the determined vehicle parking position.

In this case, the valet parking method, after the (e) vehicle parking step, may further include (f) a vehicle parking information notification step of informing the driver of the vehicle of the parking position information of the parked vehicle.

In this case, the valet parking method, after the (e) vehicle parking step, may further include (g) a vehicle parking zone operation step in which while the vehicle is parked, the second vehicle transfer robot moves the vehicle from a first vehicle parking zone located in front of the vehicle transfer rail in the transfer direction to a second vehicle parking zone located behind the vehicle transfer rail.

In this case, in the (g) vehicle parking zone operation step, a vehicle occupancy rate of the first vehicle parking zone is compared with a vehicle occupancy rate of the second vehicle parking zone, and when the vehicle occupancy rate of the first vehicle parking zone is greater than the vehicle occupancy rate of the second vehicle parking zone, vehicles in the first vehicle parking zone may be moved to the second vehicle parking zone.

In this case, in the (g) vehicle parking zone operation step, only when the vehicle occupancy rate of the first vehicle parking zone exceeds a preset occupancy rate, vehicles in the first vehicle parking zone may be moved to the second vehicle parking zone.

According to yet another aspect of the present disclosure, provided is a valet vehicle pickup method for delivering a vehicle parked in a vehicle parking zone of an airport to a driver, and the valet vehicle pickup method includes (a) a pickup vehicle and driver information providing step of receiving information on a vehicle parked in the vehicle parking zone and its driver from a driver who wishes to pick up the vehicle; (b) a vehicle checking step of checking a vehicle parked in the vehicle parking zone; (c) a vehicle transfer step using a vehicle transfer robot to move the vehicle parked at the vehicle parking zone to a vehicle transfer pallet on a vehicle transfer rail using a second vehicle transfer robot; (d) a vehicle transfer step using a vehicle transfer pallet to transfer the vehicle transferred to the vehicle transfer pallet to a location near the driver riding zone where the vehicle is picked up; and (e) a pickup vehicle waiting step of moving the vehicle near the driver riding zone to the driver riding zone using a first vehicle transfer robot and making the vehicle to wait so that the driver can pick up the vehicle.

In this case, the valet vehicle pickup method, after the (e) vehicle waiting step, may further include (f) a pickup completion step of notifying that pickup of the vehicle has been completed after the driver rides the vehicle.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a configuration diagram of an airport valet parking system according to an exemplary embodiment of the present disclosure.

FIG. 2 is a network layout of an airport valet parking system according to an exemplary embodiment of the present disclosure.

FIG. 3 is a diagram of a network configuration of an airport valet parking system according to an exemplary embodiment of the present disclosure.

FIG. 4 is a schematic configuration diagram of a vehicle transfer robot used in an airport valet parking system according to an exemplary embodiment of the present disclosure.

FIG. 5 shows a vehicle transfer robot used in an airport valet parking system according to an exemplary embodiment of the present disclosure.

FIG. 6 is a schematic configuration diagram of a mobile pallet used in an airport valet parking system according to an exemplary embodiment of the present disclosure.

FIG. 7 is a diagram showing a state in which a vehicle transfer robot is located adjacent to a mobile pallet and a vehicle transfer rail used in an airport valet parking system according to an exemplary embodiment of the present disclosure.

FIG. 8 is a conceptual diagram for describing a state in which a first vehicle transfer robot transfers a vehicle between a terminal and a vehicle transfer rail in an airport valet parking system according to an exemplary embodiment of the present disclosure.

FIG. 9 is a detailed configuration diagram of a vehicle parking zone of an airport valet parking system according to an exemplary embodiment of the present disclosure.

FIG. 10 is a flowchart of a method for valet parking in an airport according to an exemplary embodiment of the present disclosure.

FIG. 11 is a flowchart illustrating a step of vehicle parking zone operation in a method for airport valet parking according to an exemplary embodiment of the present disclosure.

FIG. 12 is a flowchart of a method for picking up a valet vehicle in an airport according to an exemplary embodiment of the present disclosure.

FIG. 13 is a configuration diagram of an airport valet parking system according to another exemplary embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

An airport valet parking system according to an exemplary embodiment of the present disclosure may be a system installed within or around an airport to allow visitors at the airport to valet park their vehicles in a vehicle parking zone within or around the airport.

In addition, an airport valet parking system according to an exemplary embodiment of the present disclosure may automatically transfer a vehicle to a vehicle parking zone using a vehicle transfer robot and a vehicle transfer pallet capable of moving the vehicle after a driver gets off the vehicle, or may automatically transfer the vehicle from the vehicle parking zone to a driver riding zone where the driver may pick up the vehicle.

Hereinafter, an airport valet parking system according to some exemplary embodiments of the present disclosure will be described in more detail with reference to the drawings.

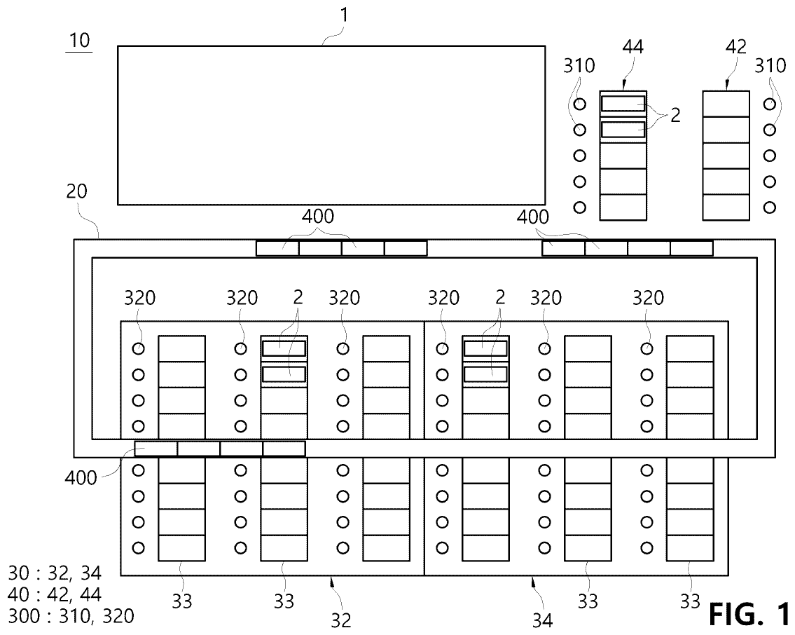

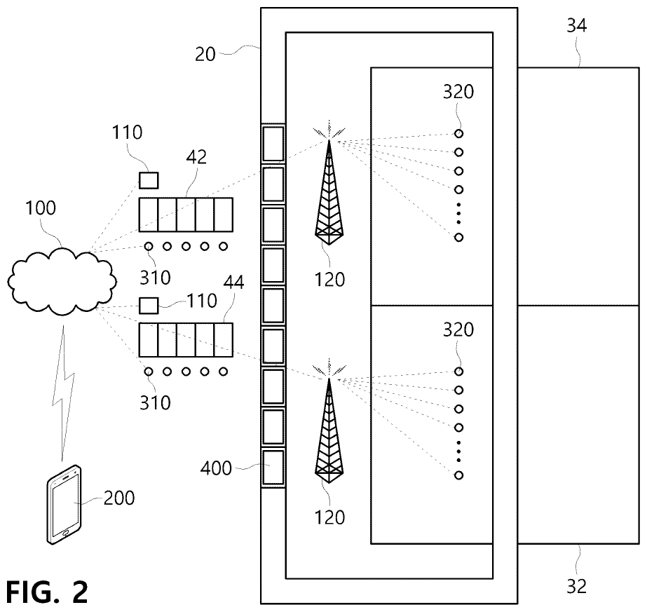

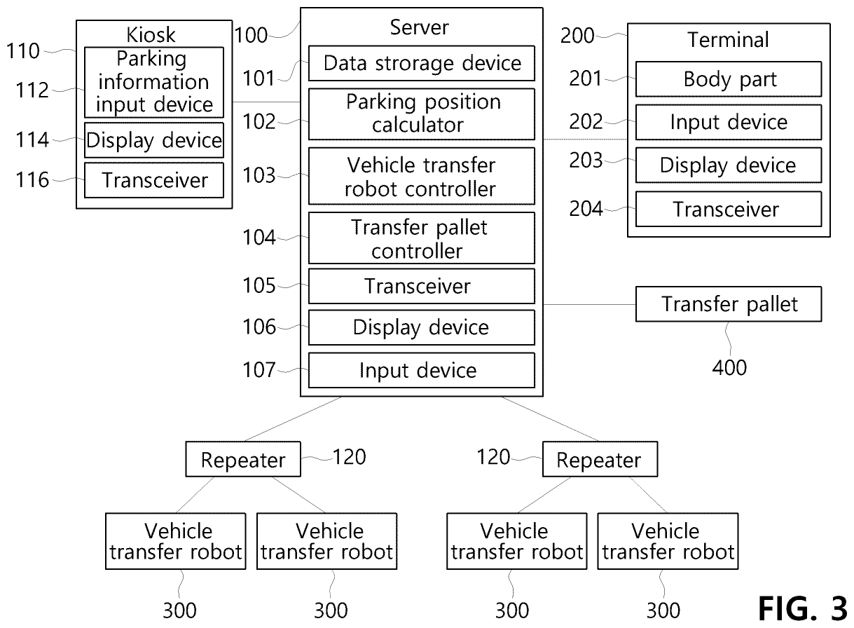

FIG. 1 is a configuration diagram of an airport valet parking system according to an exemplary embodiment of the present disclosure. FIG. 2 is a diagram of a network layout of an airport valet parking system according to an exemplary embodiment of the present disclosure. FIG. 3 is a diagram of a network configuration of an airport valet parking system according to an exemplary embodiment of the present disclosure.

Referring to FIGS. 1 to 3, an airport valet parking system 10 according to an exemplary embodiment of the present disclosure includes a first vehicle transfer robot 310, a vehicle transfer pallet 400, a vehicle transfer rail 20, a second vehicle transfer robot 320, and a server 100.

The first vehicle transfer robot 310 may be a robot that is movably located in a vehicle stop zone 40 where a vehicle 2 for valet parking is stopped to move the vehicle 2 stopped in the vehicle stop zone 40.

In this case, the first vehicle transfer robot 310 may be configured as a parking robot. In the present disclosure, the term “parking robot” refers to a robot capable of moving the parking or stopping position of a vehicle by lifting the vehicle in a stopped or parked place.

Referring to FIG. 1, a plurality of the first vehicle transfer robots 310 may be located in the vehicle stop zone 40 provided near an airport terminal 1 so that a driver can stop a vehicle 2.

In an embodiment of the present disclosure, the vehicle stop zone 40 may include a driver drop-off zone 44 and a driver riding zone 42.

The driver drop-off zone 44 is a zone where a vehicle 2 that enters the airport for requesting valet parking stops briefly and a driver can get off from the vehicle 2. A plurality of driver drop-off spaces or positions where vehicles may stop or be temporarily parked are designated in the driver drop-off zone 44.

The first vehicle transfer robot 310 may be positioned on the side of the vehicle 2 to transport the vehicle 2 when the vehicle 2 requiring valet parking is stopped at a driver drop-off space or position in the driver drop-off zone 44 and the driver gets off from the vehicle 2, and may move or transfer the vehicle 2 according to a control command from the server 100.

Meanwhile, the driver riding zone 42 is a zone where the driver can pick up or ride the vehicle 2 transferred from a vehicle parking zone 30. A driver riding position where the vehicle may stop is designated in the driver riding zone 42.

The first vehicle transfer robot 310 may transfer a vehicle, for which vehicle pickup is requested, to a driver riding position in the driver riding zone 42. In this way, the driver may pick up the vehicle 2 while the vehicle 2 is transferred to the driver riding position.

The driver drop-off zone 44 and the driver riding zone 42 may be located in adjacent positions or may be located in positions away from each other.

According to an exemplary embodiment of the present disclosure, the driver drop-off zone 44 and the driver riding zone 42 are located parallel to each other at separate locations, and a plurality of first vehicle transfer robots 310 are arranged in each of the driver drop-off zone 44 and the driver riding zone 42, although not required.

Meanwhile, the vehicle transfer rail 20 is disposed near the vehicle stop zone 40. A vehicle transfer pallet 400 for transporting a vehicle is movably installed on the vehicle transfer rail 20.

The vehicle transfer pallet 400 is configured to transport the vehicle 2 from the vehicle stop zone 40 to the vehicle parking zone 30 along the vehicle transfer rail 20.

According to an exemplary embodiment of the present disclosure, the vehicle parking zone 30 may be divided into a plurality of parking zones such as a first vehicle parking zone 32 and a second vehicle parking zone 34. In the present disclosure, it will be described that when it is not necessary to distinguish between the first vehicle parking zone and the second vehicle parking zone, it is collectively referred to as the vehicle parking zone 30, which includes both the first vehicle parking zone 32 and the second vehicle parking zone 34.

The first vehicle parking zone 32 may be a long term parking zone in which a long-term parking vehicle that needs to be parked for a predetermined period or longer, for example, a week or 10 days or more, is parked.

In addition, the second vehicle parking zone 34 may be a short term parking zone in which a short-term parking vehicle that needs to be parked for a period shorter than a predetermined period, for example, a period of less than a certain period is parked.

According to an exemplary embodiment of the present disclosure, the vehicle transfer rail 20 passing through the vehicle parking zone 30 circulates without a start and an end, as shown in FIGS. 1 and 2. In addition, the vehicle transfer pallet 400 moving on the vehicle transfer rail 20 may circulate in one direction such as counterclockwise on the vehicle transfer rail 20 with multiple pallets connected to each other. In this case, the operation of stopping and moving the vehicle transfer pallet 400 circulating along the vehicle transfer rail 20 may be controlled by a transfer pallet controller included in a server configured to control driving of the vehicle transfer pallet 400.

The second vehicle transfer robot 320 is movably located in the vehicle parking zone 30. A plurality of second vehicle transfer robots 320 may be located in the vehicle parking zone 30. The second vehicle transfer robot 320 is positioned in the vehicle parking zone 30 to move the vehicle 1 carried by the vehicle transfer pallet 400 to the vehicle parking position 33 in the vehicle parking zone 30, or to move the vehicle 2 parked at the vehicle parking position 33 to the vehicle transfer pallet 400.

In an embodiment of the present disclosure, the first vehicle transfer robot 310 and the second vehicle transfer robot 320 may be configured as same parking robots having the same shape and function. A detailed description thereof will be described later. In the description of the vehicle transfer robot in this disclosure, when it is not specifically referred to as “first vehicle transfer robot” and “second vehicle transfer robot”, but referred to as “vehicle transfer robot”, it should be understood that it includes both the first vehicle transfer robot and the second vehicle transfer robot.

Meanwhile, according to an exemplary embodiment of the present disclosure, the server 100 is configured to control the first vehicle transfer robot 310, the vehicle transfer pallet 400, and the second vehicle transfer robot 320.

Referring to FIG. 3, the server 100 may include a data storage device 101, a parking position calculator 102, a vehicle transfer robot controller 103, a transfer pallet controller 104, a transceiver 105, a display device 106, and an input device 107.

The data storage device 101 includes at least one volatile and/or nonvolatile memory, and is configured to store commands or various types of data related to other components. Furthermore, the data storage device 101 may store software or programs. The program includes a kernel, middleware, application programming interface (API), and application program, and this structure allows programmed tasks to be performed within the apparatus by accessing individual components within the server 100.

In an embodiment of the present disclosure, the data storage device 101 may store vehicle parking request information transmitted from the driver, the driver's airport use/history record, for example, information on a departing flight number, flight departure time, arriving flight number, flight arrival time, and the like. In addition, the data storage device 101 may store information on the parking position of the parked vehicle.

The parking position calculator 102 is configured to perform an operation for designating a position where the vehicle will be parked. The parking position calculator 102 may be a part of at least one of a central processing unit, an application processor AP, and a communication processor CP.

According to an exemplary embodiment of the present disclosure, the location or space of the parked vehicle parked in the vehicle parking zone may be assigned or changed depending on the parking period and schedule of the parked vehicle, thereby efficiently using the vehicle parking zone according to the vehicle parking space occupancy rate within a limited space.

In an embodiment of the present disclosure, a long-term parking vehicle may be assigned in the first vehicle parking zone 32, and a short-term parking vehicle may be assigned in the second vehicle parking zone 34.

In addition, vehicles with less time left for vehicle pickup may be moved to a location closer to the driver riding zone 42, so that the driver can quickly pick up the vehicle in the driver riding zone 42.

In this case, while a vehicle is parked in the vehicle parking zone 30, when there is not much movement of vehicles such as during evening or night, the vehicle transfer robot may move the vehicle from a congested area where more vehicles are parked to an area where less vehicles are parked.

Accordingly, sufficient spare parking space can be secured in the first vehicle parking zone 32 while the operations of the airport valet parking system 10 are less busy (e.g. during the night) so that vehicles can be parked in the first vehicle parking zone 32 at a faster speed during the day time when valet parking is frequent.

As such, according to an exemplary embodiment of the present disclosure, the parking position calculator 102 determines where a vehicle for which valet parking is requested should be parked by considering the occupancy rate of the parking space within the overall vehicle parking zone 30. And, the parking position calculator 102 can move the vehicle 2 by controlling or operating the second vehicle transfer robot 320 in the first vehicle parking zone 32 and the second vehicle parking zone 34 according to the determination result. Therefore, according to an exemplary embodiment of the present disclosure, the vehicle parking zone 30 can be used or managed efficiently and the time for parking and taking out the vehicle can be reduced saved.

The vehicle transfer robot controller 103 of the server 100 is configured to control the vehicle transfer robot 300. According to an exemplary embodiment of the present disclosure, the vehicle transfer robot 300 includes a first vehicle transfer robot 310 located in the vehicle stop zone 40 to transfer a vehicle and a second vehicle transfer robot 320 located in the vehicle parking zone 30 to transfer a vehicle.

In addition, the vehicle transfer robot controller 103 controls the position and operation of the first vehicle transfer robot 310 and the second vehicle transfer robot 320, respectively. In this case, in an embodiment of the present disclosure, a plurality of first vehicle transfer robots 310 and a plurality of second vehicle transfer robots 320, for example, several tens of units may be operated. In addition, the vehicle transfer robot 300, which is operated in several tens of units, can be operated so that the movement distance, movement path, and operation method ensure the most efficient processes or ways of parking and taking out of vehicles. For the efficient operation of such several tens of vehicle transfer robots, the vehicle transfer robot controller 103 may use a known control program or an operation method according to learning of the artificial neural network.

Meanwhile, the transfer pallet controller 104 controls or operates the vehicle transfer pallet 400 configured to be movable on the vehicle transfer rail 20 in conjunction with the vehicle transfer robot controller 103.

The vehicle transfer pallet 400 may be configured to operate unmanned and autonomously with a vehicle loaded on the vehicle transfer pallet 400. The transfer pallet controller 104 may monitor the stop and movement of the vehicle transfer pallet 400 and the status of vehicles loaded on the plurality of vehicle transfer pallets 400. And, the vehicle transfer pallet 400 controls the stopping and movement of the vehicle transfer pallet 400 by determining where the vehicle transfer pallet 400 should stop and move for parking and taking out of the vehicle.

In this case, when the vehicle transfer pallet 400 stops in the vehicle stop zone 40 or the vehicle parking zone 30, in conjunction with the vehicle transfer robot controller 103, the transfer pallet controller 104 may control the vehicle transfer robot 300 to transport and load the vehicle on the vehicle transfer pallet 400. In addition, the transfer pallet controller 104 controls the vehicle loaded on the vehicle transfer pallet 400 to be removed from or moved out of from the vehicle transfer pallet 400 and moved to the vehicle stop position or vehicle parking position 33.

The transceiver 105 is configured to wirelessly communicate with the server 100, the vehicle transfer robot 300 and/or the vehicle transfer pallet 400.

Meanwhile, the display device 106 is configured to display various types of information to an operator who operates the server 100. The display device 106 provides a visual interface configured to visually display the operating status of the valet parking system 10 to the operator.

The input device 107 is configured to allow the operator to input control commands related to the valet parking system 10 or provide an input interface configured to receive control commands related to the valet parking system 10 through an input device such as a keyboard or mouse.

The server 100 including the display device 106 and the input device 107 may be located in the airport terminal, and may be managed and operated by the airport operating entity along with facilities, controllers, and communication devices essential to operate the airport. However, the server 100 may be located outside of the airport terminal and communicationally connected to the valet parking system 10 to remotely control the valet parking system 10.

Meanwhile, according to an exemplary embodiment of the present disclosure, a kiosk 110 may be disposed in the vehicle stop zone 40. For example, one or more kiosks 110 may be disposed in the driver riding zone 42 and the driver drop-off zone 44, respectively.

The kiosk 110 may include an information input device or interface 112 for inputting information on a vehicle temporarily stopped in the vehicle stop zone 40 and a driver of the vehicle, and a display device 114 for displaying the input vehicle and driver information. In addition, the kiosk 110 may be equipped with a transceiver 116 configured to transmit and receive the vehicle and driver information to and from a server. In addition, the kiosk 110 may be provided with a payment system for processing payment related to vehicle valet parking.

Optionally, a repeater 120 may be installed between the server 100 and the vehicle stop zone 40 and vehicle parking zone 30. The repeater 120 relays communication between the server 100 and the kiosk 110 located in the vehicle stop zone 40 or the vehicle transfer robot 300 located in the vehicle parking zone 30, and the vehicle transfer pallet 400. A plurality of repeaters 120 may be installed or not installed depending on the location and installation area characteristics of the server 100, the kiosk 110, the vehicle transfer robot 300, and the vehicle transfer pallet 400 in the airport.

In an embodiment of the present disclosure, a driver may input or provide vehicle information for an user and parking to the server 100 operating the valet parking system 10 using a terminal 200. To this end, a program linked to the valet parking system 10 may be installed in the driver's terminal 200. For example, the terminal 200 may be a mobile phone, portable PC, tablet, laptop, etc. Through a program installed on the terminal 200, the user may input user information and transmit and receive vehicle parking information. However, the user can input the user and vehicle information to the server 100 through a webpage without the installation of the program to the terminal 200.

The terminal 200 may include a body part 201 having a display device 203 through which the user may check information. The user may input or transmit user information to the server 100 through the transceiver 204 before arrival at the airport using a input method such as a method of using a touch screen interface implemented in the display device 203 or an input device 202 such as an input button separately provided in the terminal 200 to proceed with a vehicle parking reservation or pre-payment. In this way, when the user makes a vehicle parking reservation using the terminal 200 or makes a pre-payment for the valet parking, the user may use the valet parking system 10 without using the kiosk for paying fees associated with the valet parking or inputting information required for the valet parking.

Hereinafter, the vehicle transfer robot 300, the vehicle transfer pallet 400, and the vehicle parking zone 30 comprised in the valet parking system 10 according to an exemplary embodiment of the present disclosure will be described in detail with reference to other figures.

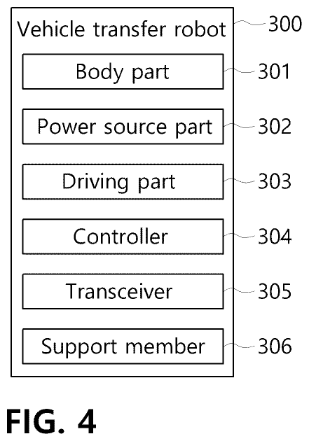

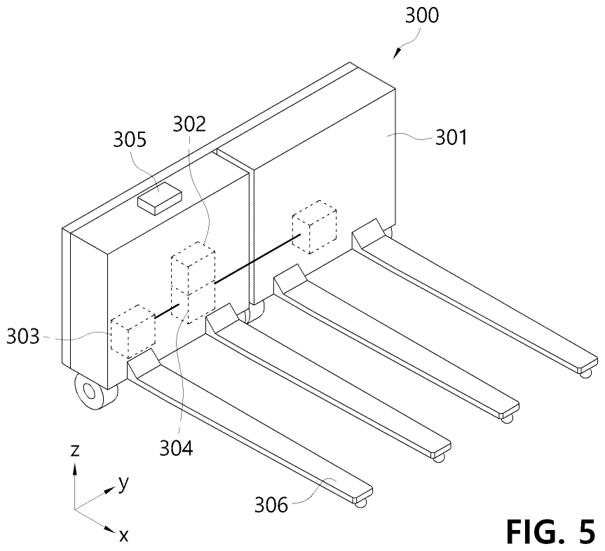

FIG. 4 is a schematic configuration diagram of a vehicle transfer robot used in an airport valet parking system according to an exemplary embodiment of the present disclosure. FIG. 5 shows a vehicle transfer robot used in an airport valet parking system according to an exemplary embodiment of the present disclosure.

Referring to FIGS. 4 and 5, the vehicle transfer robot 300 used in the valet parking system 10 in an airport according to an exemplary embodiment of the present disclosure may include a body part 201, a power source part 302, a driving part 303, a controller 304, and a transceiver 305.

Referring to FIG. 5, the body part 301 may has a rigid frame extending in the y-axis direction. The body part 301 protects the power source part 302, the driving part 303, and the controller 304 by embedding the power source part 302, the driving part 303, and the controller 304 in the body part 301. The power source part 302 is configured to supply power for driving the vehicle transfer robot 300. For example, the power source part 303 may be a rechargeable battery module or the like.

The driving part 303 may include a driving motor configured to drive one or more wheels installed at the lower part of the body part 301 to move the body part 301 and a power transmission member configured to transmit driving force from the driving motor to the wheel. The power transmission member may comprise, for example, but not limited to, one or more gears, one or more belts or combination thereof.

Meanwhile, the driving part 303 may include two pairs of cantilever-type support members 306 capable of lifting the wheels or body of the vehicle 2 to transfer the vehicle 2 and a driving module (e.g. a motor) for operating the support members 306.

The vehicle transfer robot 300 according to an exemplary embodiment of the present disclosure may be configured to lift a pair of front wheels and a pair of rear wheels of a vehicle using the two pairs of cantilever-type support members 306. In this way, the vehicle transfer robot 300 can transport or move the vehicle by moving the body part 301 while lifting the front and rear wheels of the vehicle.

Meanwhile, the vehicle transfer robot 300 may be controlled to move according to a command received from the server 100 through the transceiver 305, or may be configured such that the controller 304 provided in the vehicle transfer robot 300 autonomously moves or controls the vehicle transfer robot 300 by calculating and determining a moving path in the vehicle stop zone 40 or the vehicle parking zone 20 based on parking location information and driver information received from the server 100.

According to an exemplary embodiment of the present disclosure, each of the plurality of vehicle transfer robots 300 is configured to move the vehicle in a limited or set area, for example an area between the vehicle stop zone 40 and the vehicle transfer pallet 400, or an area between the vehicle transfer pallet 400 and the vehicle parking position 33 within the vehicle parking zone 30. By limiting the movable area of the vehicle transfer robots 300, the vehicle can be moved or parked at a close distance for efficient operations.

The vehicle transfer robot 300 configured for vehicle transfer is preferably provided to make the size as small as possible and to move quickly even within a narrow space. If the size and weight of the vehicle transfer robot 300 are smaller and lighter, the parking space can make narrower or moving space for the vehicle transfer robot 300 within the vehicle stop zone 40 or the vehicle parking zone 30 can be reduced.

In addition, if the vehicle transfer robot 300 receives or uses power from a rechargeable battery, etc., a charging system for the vehicle transfer robot 300 may be separately provided at one or more locations in the vehicle stop zone 40 and the vehicle parking zone 30 so that the vehicle transfer robot 300 may be charged in an inoperative or standby state.

The vehicle transfer robot 300 that may be used in the valet parking system 10 according to an exemplary embodiment of the present disclosure may be provided to transport or move a vehicle in an airport parking lot or a parking lot having a narrow parking space according to the present embodiment.

However, the vehicle transfer robot 300 described in an exemplary embodiment of the present disclosure is exemplary, and the shape and driving method and configurations of the vehicle transfer robot 300 are not limited thereto.

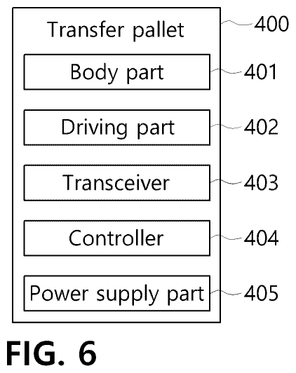

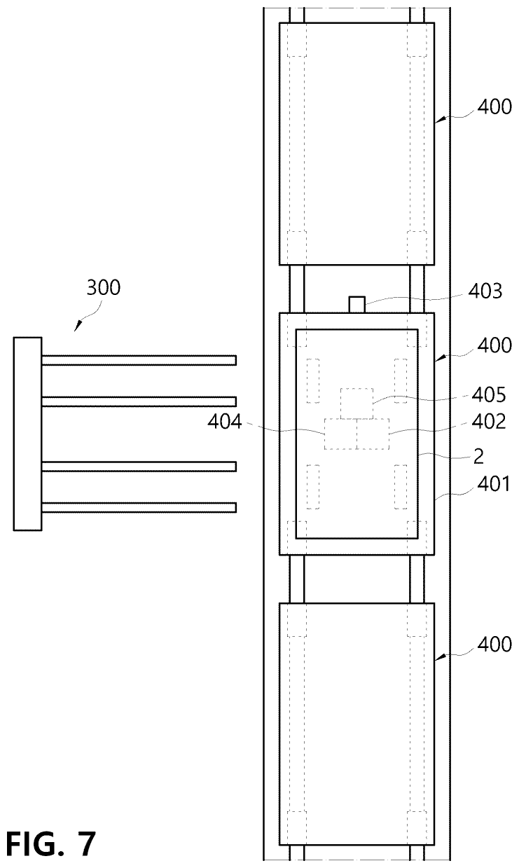

FIG. 6 is a schematic configuration diagram of a mobile pallet used in an airport valet parking system according to an exemplary embodiment of the present disclosure. FIG. 7 is a diagram showing a state in which a vehicle transfer robot is located adjacent to a mobile pallet and a vehicle transfer rail used in an airport valet parking system according to an exemplary embodiment of the present disclosure.

Referring to FIGS. 6 and 7, the vehicle transfer pallet 400 may include a body part 401, a driving part 402, a transceiver 403, a controller 404, and a power supply part 405.

The vehicle transfer pallet 400 is an apparatus configured to move on or along the vehicle transfer rail 20. The body part 401 may include, for example, but not limited to, a quadrangular plate-shaped frame in which a vehicle may be loaded on the top thereof. A fixing member may be provided on the top of the body part 401 to fix the position of the vehicle loaded on top of the body part 401.

A plurality of wheels may be installed at the bottom of the body part 401, and the plurality of wheels may be driven by, for example, the driving part 402 including a driving motor. In this case, the structure in which wheels are installed on the bottom of the body part 401 may be implemented in various known structures that allow the body part 401 to be moved on the vehicle transfer rail 20.

In an embodiment of the present disclosure, the power supply part 405 (e.g. a rechargeable battery) for supplying power may be connected to the driving part 402 of the transfer pallet 400, and a transfer pallet controller 404 may be provided to control the driving of the driving part 402.

In an embodiment of the present disclosure, the operation and control of the vehicle transfer pallet 400 may be performed by the controller 404 based on data and a command signal received from the server 100.

In this case, the data received from the server 100 may include information on a location where the vehicle transfer pallet 400 should stop in the vehicle stop zone 40 and the vehicle parking zone 30, information on a time when the vehicle transfer pallet 400 should move, information on the type and weight of a vehicle loaded on the vehicle transfer pallet 400, and any information related to transport of the vehicle.

Additionally or optionally, the vehicle transfer pallet 400 further comprises an alarm device for preventing an accident that may occur during the operation of the vehicle transfer pallet 400 or notifying a safety accident that may occur during vehicle transfer, a brake system for forcibly stopping the vehicle transfer pallet 400, and the like.

Since the configuration of the vehicle transfer pallet 400 may be implemented in a manner similar to a known transportation means for trains and rails, a detailed description thereof will be omitted.

Referring to FIG. 7, in an embodiment of the present disclosure, the vehicle transfer robot 300 may be configured to position a vehicle on the vehicle transfer pallet 400 while the vehicle transfer pallet 400 is stopped on the vehicle transfer rail 20. To this end, the vehicle transfer robot 300 may be configured to lift the cantilever-type support members 306 of the vehicle transfer robot 300 above the height of the upper surface of the vehicle transfer pallet 400 in an upward direction. Alternatively, as another example, a lifting device configured to lift or elevate the vehicle transfer robot 300 while the vehicle transfer robot 300 is transporting or loading the vehicle may be provided on the side part of the vehicle transfer rail 20 where the vehicle transfer pallet 400 stops.

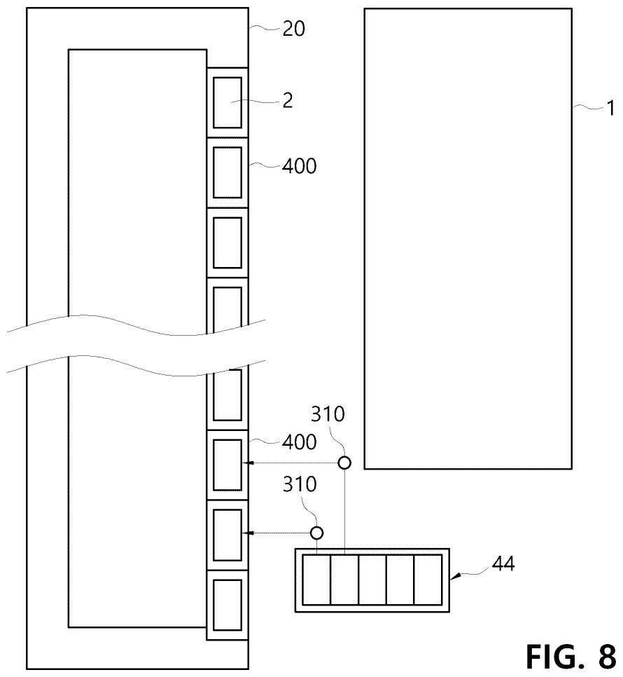

FIG. 8 is a conceptual diagram for describing a state in which a first vehicle transfer robot transfers a vehicle between a terminal and a vehicle transfer rail in an airport valet parking system according to an exemplary embodiment of the present disclosure.

In an embodiment of the present disclosure, the vehicle stop zone 40 may be located in an area in front of or adjacent to an airport terminal where it is easy for airplane passengers to enter the terminal. In the vehicle stop zone 40, vehicle stop positions may be arranged in parallel so that a plurality of vehicles may be stopped in parallel. In addition, in order to transport a stopped vehicle located at each vehicle stop position, a plurality of first vehicle transfer robots 310 may reciprocate between the vehicle transfer rail 20 and the vehicle stop zone 40.

In this case, to transport the vehicle using the vehicle transfer pallet 400, a plurality of connected vehicle transfer pallets 400 may move along the vehicle transfer rail 20 and be located in front of or adjacent to the vehicle stop zone 40. In this case, the plurality of vehicle transfer pallets 400 may stop in the driver riding zone 42 and then drop off the vehicle transferred from the vehicle parking zone 30 before stopping in the driver drop-off zone 44.

In a state in which the vehicle transfer pallet 400 stops in the driver drop-off zone 44, the vehicle transfer robot 300 that transfers the stopped vehicle may move to the side of the vehicle transfer pallet 400 with an empty vehicle loading space through communication with the server 100 to load the vehicle 2 on the vehicle transfer pallet 400.

After a plurality of vehicles are loaded on each of the plurality of vehicle transfer pallets 400, the plurality of vehicle transfer pallets 400 may be moved to the vehicle parking zone 30 through communication with the server 100.

In addition, a plurality of second vehicle transfer robots 320 may approach each of the plurality of vehicle transfer pallets 400 moved from the driver drop-off zone 44 to the vehicle parking zone 30 and transfer each of the plurality of vehicles to a preset vehicle parking zone 30.

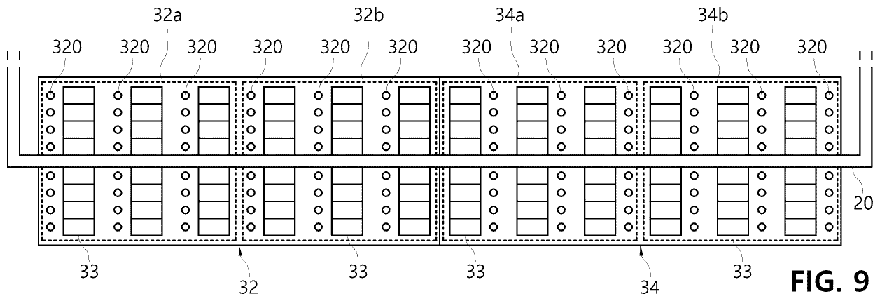

FIG. 9 is a detailed configuration diagram of a vehicle parking zone of an airport valet parking system according to an exemplary embodiment of the present disclosure.

Referring to FIGS. 1, 2, and 9, the vehicle parking zone 30 may be divided into a plurality of vehicle parking zones such as a first vehicle parking zone 32 and a second vehicle parking zone 34.

In an embodiment of the present disclosure, the first vehicle parking zone 32 may be a zone for parking long-term parking vehicles that need to be parked for a predetermined period or longer, for example, a week or 10 days or more.

In addition, the second vehicle parking zone 34 may be a zone for parking short-term parking vehicles that need to be parked for a period of less than a predetermined period, for example, a period of less than a certain period. In the present embodiment, the vehicle parking zone is divided into the first vehicle parking zone 32 for parking long-term parking vehicles and the second vehicle parking zone 34 for parking short-term parking vehicles. Alternatively, the server 100 may control and manage an area where the long-term vehicle is parked and an area where the short-term vehicle is parked within the vehicle parking zone 30 without dividing a parking zone into a plurality of the parking zones for the long-term and short-term vehicles.

In addition, referring to FIG. 9, the first vehicle parking zone 32 may be divided into first areas 32a and 34a and the second vehicle parking zone 34 may be divided into second areas 32b and 34b to operate to park a vehicle parked longer than the second areas 32b and 34b in the first areas 32a and 34a within each area for each vehicle parking period.

Meanwhile, according to an exemplary embodiment of the present disclosure, as can be seen in FIGS. 1, 2, and 9, the vehicle parking positions 33 may be arranged in a plurality of rows in a direction perpendicular to a direction in which the vehicle transfer rail 20 extends.

In this case, the direction and arrangement of the vehicle parking positions 33 may vary depending on the topography and location of the parking space. In this case, the direction and arrangement of the vehicle parking positions 33 may be configured so that the second vehicle transfer robot 320 can safely transfer the vehicle while moving the vehicle. Meanwhile, between the vehicle parking position 33 and the vehicle movement rail 20, there may be an interval and a distance sufficient to transfer the vehicle while the second vehicle transfer robot 320 moves.

In an embodiment of the present disclosure, the vehicle parking zone 30 may have a wide flat area far from the terminal 1, and as shown in FIGS. 1, 2, and 9, the vehicle transfer rail 20 may pass through the vehicle parking zone 30. The configuring the vehicle transport rail 20 passing through the vehicle parking zone 30 can shorten the distance for the vehicle transfer robot 300 to move the vehicle on the vehicle transfer pallet 400 to the vehicle parking position 33 in the vehicle parking zone 30 in a pause while the vehicle transfer pallet 400 passes through the vehicle parking zone 30 along the vehicle transfer rail 20.

Meanwhile, according to an exemplary embodiment of the present disclosure, the vehicle transfer rail 20 passing through the vehicle parking zone 30 may have an infinite track without a start and an end, as shown in FIGS. 1, 2 and 9. In addition, the vehicle transfer pallet 400 moving on the vehicle transfer rail 20 may circulate in one direction such as counterclockwise on the vehicle transfer rail 20 with multiple pallets connected to each other.

In this case, the stopping and operating of the vehicle transfer pallet 400 circulating along the vehicle transfer rail 20 may be controlled by the transfer pallet controller 404 in the server 100 that controls the driving of the vehicle transfer pallet 400.

In this case, according to an exemplary embodiment of the present disclosure, the first vehicle parking zone 32 in which the vehicle parks for a long period of time may be located closer to the terminal 1 than the second vehicle parking zone 34 in consideration of the moving direction of the vehicle transfer pallet 400 of the vehicle transfer rail 20.

Accordingly, the vehicle transfer pallet 400 moved from the vehicle stop zone 40 of the terminal 1 is configured to first arrive in the first vehicle parking zone 32 and then pass through the first vehicle parking zone 32, and then pass through the second vehicle parking zone 34.

As such, the configuration of the vehicle transfer pallet 400 moved from the vehicle stop zone 40 of the terminal 1 to first pass through the first vehicle parking zone 32 is to operate the vehicle parking zone 30 to park a long-term parking vehicle parked closer to the vehicle stop zone 40, more specifically the driver drop-off zone 44 where the driver gets off and valet park the vehicle, and to park a short-term parking vehicle parked in a location farther from the driver drop-off zone 44.

In this case, the second vehicle parking zone 34 for parking the short-term parking vehicle may be located closer to the driver riding zone 42 in which the driver picks up the vehicle.

Accordingly, when a short-term parking vehicle is picked up by the driver, the distance at which the vehicle is moved from the second vehicle parking zone 34 to the driver riding zone 42 may be shorter than a vehicle parked in the first vehicle parking zone 32, thereby saving time for vehicle pickup.

Meanwhile, as described above, the second vehicle transfer robot 320 is movably located in the vehicle parking zone 30. A plurality of second vehicle transfer robots 320 may be located in the vehicle parking zone 30.

The second vehicle transfer robot 320 is located in the vehicle parking zone 30 to move the vehicle carried by the vehicle transfer pallet 400 to the vehicle parking position 33 in the vehicle parking zone 30, or to move the parked vehicle located at the vehicle parking position 33 to the vehicle transfer pallet 400.

The second vehicle transfer robot 320 may be allowed to move only within a specific or predetermined area within a part of the vehicle parking zone 30 rather than transferring the vehicle while moving in the entire vehicle parking zone 30 to make the moving distance of the second vehicle transfer robot 320 shorter. In addition, to supply power to the vehicle transfer robot 300, one or more charging facilities or chargers may be provided at one or more locations in the vehicle parking zone 30 to supply electricity to the vehicle transfer robot 300 during its standby time of the vehicle transfer robot 300 or a downtime such as night.

Hereinafter, a method for valet parking in an airport according to an exemplary embodiment of the present disclosure will be described with reference to drawings.

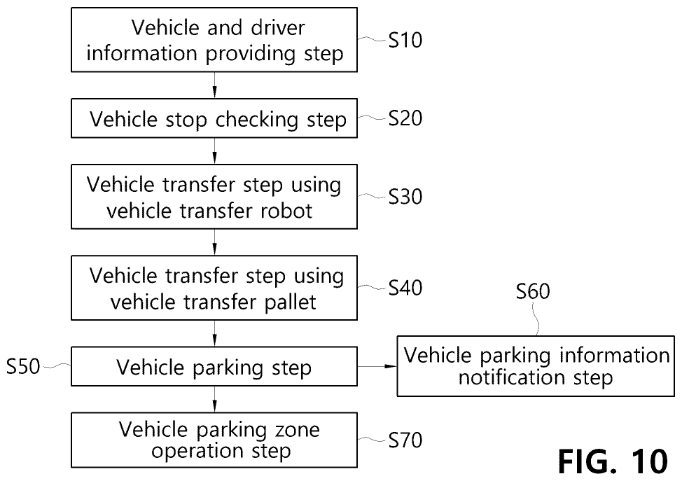

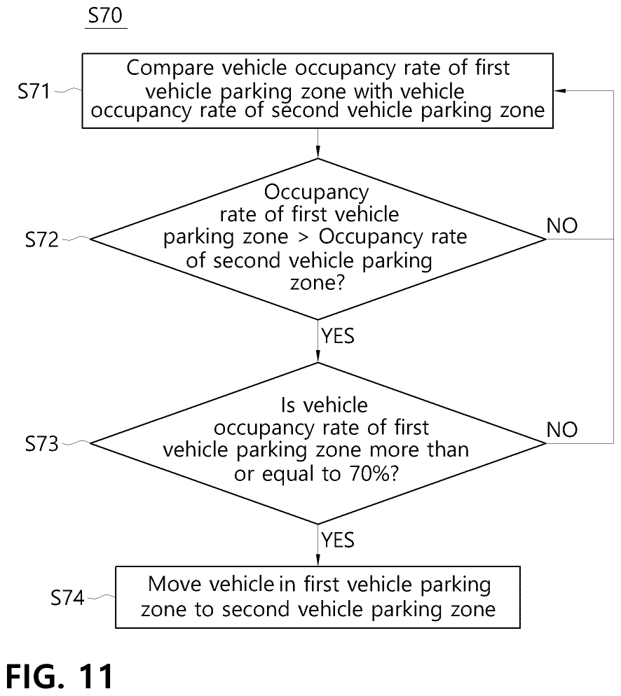

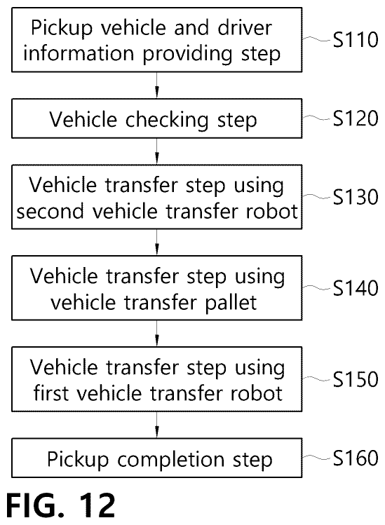

FIG. 10 is a flowchart of a method for valet parking in an airport according to an exemplary embodiment of the present disclosure. FIG. 11 is a flowchart illustrating a step of a vehicle parking zone operation in a method for valet parking in an airport according to an exemplary embodiment of the present disclosure. FIG. 12 is a flowchart of a method for picking up a valet vehicle in an airport according to an exemplary embodiment of the present disclosure.

Referring to FIG. 10, in a method for parking a valet vehicle according to an exemplary embodiment of the present disclosure, vehicle and driver information are received or provided (S10). For example, at operation S10, the vehicle and driver information may be input by the driver at a kiosk within a vehicle stop zone or provided to a server through a terminal such as a user's mobile phone or device before parking the vehicle.

When the vehicle arrives at the vehicle stop zone or is stopped in the vehicle stop zone while the user has provided the vehicle and driver information, it is checked whether a vehicle matching the user information entered in advance by the user or received from the server has been stopped in the vehicle stop zone (S20).

Whether a reserved vehicle is stopped in the vehicle stop zone may be checked through images captured through a camera installed or provided in the vehicle stop zone or an entrance of a parking facility.

Then, a first vehicle transfer robot transfers or moves the vehicle stopped in the vehicle stop zone a vehicle transfer pallet on a vehicle transfer rail (S30).

And, the vehicle transfer pallet is controlled to wait adjacent to the vehicle stop zone to load the vehicle being moved by the first vehicle transfer robot.

The vehicle transfer pallet may be controlled such that a plurality of units can move together, and after receiving vehicle transfer information regarding a vehicle to be moved and location information to be stopped in the vehicle stop zone and the vehicle parking zone from the server, the movement of the vehicle transfer pallet is controlled according to the vehicle transfer information and location information to move or transport the vehicle to the vehicle parking zone (S40).

After the vehicle transfer pallet is transferred or moved to the vehicle parking zone, a second vehicle transfer robot in the vehicle parking zone moves the vehicle from the vehicle transfer pallet to the vehicle parking position in the vehicle parking zone (S50). In this case, a plurality of vehicles may be simultaneously or sequentially moved to the vehicle parking spaces or positions.

In this case, a parking space or position in which the vehicle is to be parked is calculated and determined in advance by the server, and the second vehicle transfer robot moves the vehicle to the determined vehicle parking space or position.

Accordingly, when the parking of the vehicle to the determined vehicle parking space or position is completed, the second vehicle transfer robot is separated from the vehicle, and performs a vehicle transfer process for another vehicle or waits in a separate or predetermined location.

Optionally, information regarding where the vehicle is parked (e.g. parking position information of a parked vehicle) may be notified to a driver of the vehicle through a text message or email after parking of the vehicle is completed (S60).

Accordingly, the driver of the vehicle may check or confirm that his or her vehicle is safely parked.

In this case, the location where a vehicle is parked varies depending on a time period of parking such as long-term or short-term parking. However, sometimes, parked vehicles may be concentrated only in a specific space among parking spaces inside the vehicle parking zone. In order to prevent such inefficiency in utilizing parking spaces, in an embodiment of the present disclosure, a vehicle parking zone operation is performed (S70).

Referring to FIG. 11, in the vehicle parking zone operation (S70), while the vehicle is parked, the second vehicle transfer robot 320 moves one or more vehicles from an area with more vehicles to another area with fewer vehicles in the vehicle parking zone 30. For example, the vehicle parking zone may be divided into the first vehicle parking zone 32 and the second vehicle parking zone 34, and a vehicle occupancy rate of the first vehicle parking zone 32 and a vehicle occupancy rate of the second vehicle parking zone 34 are compared (S71).

Based on the comparison result at operation S71, it is determined whether a vehicle occupancy rate of the first vehicle parking zone 32 is greater than a vehicle occupancy rate of the second vehicle parking zone 34 (S72)

If the vehicle occupancy rate of the first vehicle parking zone 32 is greater than the vehicle occupancy rate of the second vehicle parking zone 34, the second vehicle transfer robot 320 moves one or more vehicles from the first vehicle parking zone 32 located in front of the vehicle transfer rail 20 in the transfer direction to the second vehicle parking zone 34 located behind the vehicle transfer rail 20 or farther from the vehicle transfer rail 20 than the first vehicle parking zone 32 (S74).

Additionally or alternatively, the second vehicle transfer robot 320 may move one or more vehicles parked in the first vehicle parking zone 32 to the second vehicle parking zone 34 only when the vehicle occupancy rate of the first vehicle parking zone 32 exceeds a preset occupancy rate, for example, 70% or more (S73).

By moving the parking position(s) of one or more vehicles in the vehicle parking zone 30 according to the vehicle occupancy rate of each area in the vehicle parking zone 30, the parking spaces can be efficiently used even when there are many vehicles that need to be parked in the vehicle parking zone 30, and it is also possible to quickly transfer a vehicle when the vehicle needs to be transported from the vehicle parking zone 30 to the driver riding zone so that the driver can pick it up.

FIG. 12 is a flowchart of a method for picking up a valet vehicle for delivering a vehicle parked in a vehicle parking zone to a driver.

Referring to FIG. 12, first, vehicle and driver information parked in the vehicle parking zone are provided from a driver who desires to pick up a vehicle (S110).

For example, the driver information may be travel information input when the vehicle is parked, for instance, but not limited to, flight departure information, arrival information, vehicle information, or information associated with a driver (e.g. a telephone number, an email address, a membership identification, and a name), the like, or may be information newly input by the user after arrival at the airport.

After information on the vehicle to be picked up and information on the driver are provided, the vehicle parked in the vehicle parking zone is checked (S120).

Thereafter, the vehicle parked in the vehicle parking zone is transferred to the vehicle transfer pallet using the second vehicle transfer robot (S130).

Thereafter, the vehicle transfer pallet transfers the vehicle to an area near the driver riding zone where the vehicle should be picked up (S140).

Thereafter, the first vehicle transfer robot moves the vehicle to the driver riding zone from the transfer pallet located near the driver riding zone (S150).

When the driver rides or enters the vehicle located in the driver riding zone and it is notified that the pickup of the vehicle has been completed, the operation of the pickup of the vehicle is completed (S160).

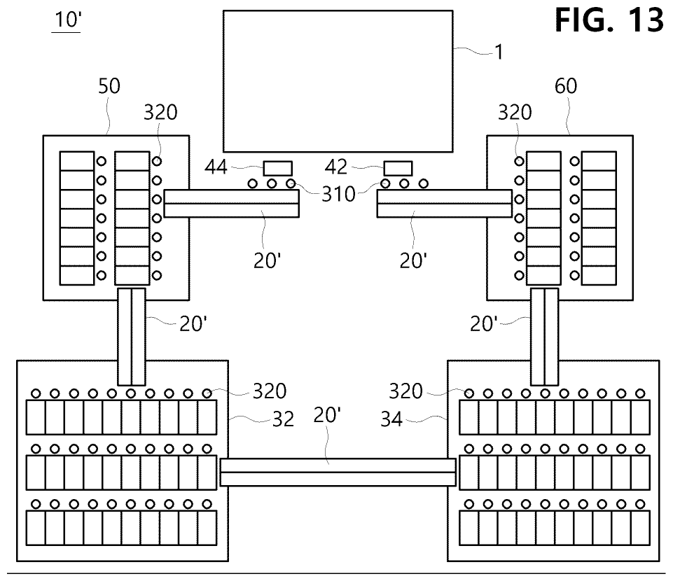

FIG. 13 is a configuration diagram of an airport valet parking system according to another exemplary embodiment of the present disclosure. In describing the airport valet parking system according to another exemplary embodiment of the present disclosure, a detailed description of a configuration identical to or similar to the above-described embodiments will be omitted, and another embodiment will be described focusing on different configurations from the exemplary embodiments described above.

Referring to FIG. 13, compared to the above-described embodiments, an airport valet parking system 10′ according to another exemplary embodiment of the present disclosure further includes a temporary parking zone 50 and a pickup waiting zone 60.

Accordingly, the vehicle moved from the driver drop-off zone 44 through the vehicle transfer rail 20 may not be directly transferred to the first vehicle parking zone 32. Instead, the vehicle moved from the driver drop-off zone 44 may be temporarily parked in the temporary parking zone 50 and then transferred to the first vehicle parking zone 32 or the second vehicle parking zone 34 through a vehicle transfer rail 20′.

By including the temporary parking zone 50, when a parking vehicle is temporarily parked in the temporary parking zone 50, if there are many vehicles to be parked or if additional time is needed to manage or maintain the vehicle parking zone 30, time for managing or maintaining the vehicle parking zone 30 may be secured before the temporarily parked vehicle in the temporary parking zone 50 is moved to the vehicle parking zone 30, thereby further increasing vehicle parking efficiency.

Detailed descriptions of configurations similar to those of the above-described embodiments among the configurations of the vehicle transfer of the vehicle transfer robot 300 within the temporary parking zone 50, the vehicle transfer rail 20 between the temporary parking zone 50, the first vehicle parking zone 32 and the second vehicle parking zone 34, and the vehicle transfer pallet 400 will be omitted.

In addition, according to another exemplary embodiment of the present disclosure, the first vehicle parking zone 32 and the second vehicle parking zone 34 are connected by the vehicle transfer rail 20′. This configuration may be for a case where the first vehicle parking zone 32 and the second vehicle parking zone 34 are far from each other. In this way, when the first vehicle parking zone 32 and the second vehicle parking zone 34 are far apart, rather than installing an infinite track type vehicle transfer rail that runs through the first vehicle parking zone and the second vehicle parking zone as in the above embodiment, using a vehicle transfer rail in which a vehicle is capable of reciprocating between the vehicle parking zones may increase space efficiency and make it easier to secure a parking space in the vehicle parking zone.

As described above, an airport valet parking system and method according to various exemplary embodiments of the present disclosure can move a vehicle from an area near a terminal of the airport to a vehicle parking zone far from the terminal of the airport to park the vehicle using a vehicle transfer robot and a vehicle transfer pallet that can automatically move the vehicle.

In addition, according to an exemplary embodiment of the present disclosure, when moving a vehicle from a vehicle stop position to a vehicle transfer pallet for a short distance or moving a vehicle placed on the vehicle transfer pallet to a vehicle parking position in the vehicle parking zone for a short distance, the vehicle can be automatically valet-parked by using a vehicle transfer robot capable of autonomous driving.

In addition, an airport valet parking system and method according to an exemplary embodiment of the present disclosure can efficiently manage or use a vehicle parking zone by moving a vehicle from an area with a higher vehicle occupancy rate (i.e. an area with more parked vehicles) to an area with a lower vehicle occupancy rate (i.e. an area with fewer parked vehicles) at a time when the vehicle parking zone is not congested, taking into account the vehicle occupancy rate within the vehicle parking zone where the vehicle is parked.

Accordingly, an airport vehicle valet parking system and valet vehicle pickup method according to an exemplary embodiment of the present disclosure can be operated to park a vehicle in a vehicle parking zone in consideration of a time period in which the vehicle is parked, and be operated to place the vehicle adjacent to the driver riding zone where the driver pick up and retrieve the vehicle up as the date of taking out the vehicle approaches, thereby handing over the vehicle to the driver more quickly.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. An automated valet parking system comprising:
at least one first vehicle transfer robot located in a vehicle stop zone where a vehicle for valet parking is stopped, the first vehicle transfer robot configured to move the vehicle stopped in the vehicle stop zone;
at least one vehicle transfer pallet configured to transport the vehicle moved by the first vehicle transfer robot;
a vehicle transfer rail installed from an area adjacent to the vehicle stop zone to a vehicle parking zone so that the vehicle transfer pallet is movable along the vehicle transfer rail;
at least one second vehicle transfer robot located in the vehicle parking zone and configured to move the vehicle transported by the vehicle transfer pallet to a vehicle parking space in the vehicle parking zone, or move a vehicle parked at the vehicle parking zone to the vehicle transfer pallet; and
a server configured to control the first vehicle transfer robot, the vehicle transfer pallet, and the second vehicle transfer robot.

2. The automated valet parking system of claim 1,
wherein the vehicle stop zone comprises:
a driver drop-off zone where a driver drops off the vehicle for the valet parking; and
a driver riding zone where the driver picks up the vehicle moved from the vehicle parking zone.

3. The automated valet parking system of claim 2,
wherein the vehicle parking zone comprises:
a first vehicle parking zone for long-term parking for a predetermined time period or longer; and
a second vehicle parking zone for short-term parking for a time period shorter than the predetermined time period.

4. The automated valet parking system of claim 3, wherein:
the at least one second vehicle transfer robot comprises a plurality of second vehicle transfer robots, and
each of the first vehicle parking zone and the second vehicle parking zone is divided into a first parking area in which one or more of the plurality of second vehicle transfer robots are operated and a second parking area in which rest of the plurality of second vehicle transfer robots is operated, and
the first parking area is located so that the vehicle transfer pallet moving along the vehicle transfer rail arrives before the second parking area.

5. The automated valet parking system of claim 3, wherein
the first vehicle parking zone is located so that the vehicle transfer pallet moving along the vehicle transfer rail arrives before the second vehicle parking zone.

6. The automated valet parking system of claim 1, wherein the vehicle transfer rail has an infinite track rail connecting between the vehicle stop zone and the vehicle parking zone.

7. The automated valet parking system of claim 1, wherein the vehicle transfer rail is arranged to pass through the vehicle parking zone.

8. The automated valet parking system of claim 1,
further comprising a kiosk placed in or around the vehicle stop zone,
wherein the kiosk is configured to:
input information about the vehicle stopped in the vehicle stop zone and a driver of the vehicle stopped in the vehicle stop zone;
display the information about the vehicle and the driver; and
transmit or receive the information about the vehicle and the driver to or from the server.

9. The airport valet parking system of claim 1,
wherein the server comprises:
a data storage device configured to store information about the vehicle parked in the vehicle parking zone and a driver of the vehicle parked in the vehicle parking zone;
a parking position calculator configured to select one of a plurality of vehicle parking spaces in the vehicle parking zone to be used to park the vehicle stopped in the vehicle parking zone;
a vehicle transfer robot controller configured to control the first and second vehicle transfer robots to move the vehicle stopped in the vehicle stop zone to the selected one of the plurality of vehicle parking spaces;
a transfer pallet controller configured to control movement of the transfer pallet on the vehicle transfer rail; and
a transceiver configured to communicate with the vehicle transfer robot controller, the first and second vehicle transfer robots, the transfer pallet controller, and the transfer pallet.

10. The automated valet parking system of claim 1, further comprising at least one repeater configured to relay signals between the server and the first vehicle transfer robot located in the vehicle stop zone or the second vehicle transfer robot located in the vehicle parking zone.

11. The automated valet parking system of claim 1,
wherein the server is configured to:
provide a program on an web accessible through a terminal, wherein the program is configured to transmit information of the vehicle and/or a driver to the server, and
receive parking information on the vehicle parked in the vehicle parking zone through the program.

12. The automated valet parking system of claim 1,
wherein each of the first vehicle transfer robot and the second vehicle transfer robot comprises:
a robot body;
cantilever-type support members provided at the robot body and configured to lift the vehicle;
a plurality of wheels provided at the robot body;
a driving motor configured to drive one or more of the plurality of wheels;
a power supply configured to supply power to the driving motor; and
a robot controller configured to control the driving motor.

13. The automated valet parking system of claim 1,
wherein the transfer pallet comprises:
a substantially plate-shaped pallet body;
a plurality of wheels provided at the pallet body;
a drive motor configured to drive one or more of the plurality of wheels;
a power supply configured to supply power to the driving motor; and
a transfer pallet controller configured to control the driving motor.

14. The automated valet parking system of claim 3, wherein:
the vehicle parking zone further comprises a first vehicle temporary parking zone and a second vehicle temporary parking zone,
the first vehicle temporary parking zone is set as a zone for temporarily park the vehicle stopped in the vehicle stop zone before transferring the vehicle stopped in the vehicle stop zone to the first vehicle parking zone, and
the second vehicle temporary parking zone is set as a zone for temporarily parking a vehicle parked in the second vehicle parking zone before transferring the vehicle parked in the second vehicle parking zone to a driver riding zone where the driver picks up the vehicle parked at the vehicle parking zone.

15. An automated valet vehicle parking method comprising:
receiving information on a vehicle and a driver for valet parking;
checking whether the vehicle is stopped in a vehicle stop zone;
controlling a first vehicle transfer robot to move the vehicle stopped in the vehicle stop zone to a vehicle transfer pallet configured to be movable along a vehicle transfer rail;
controlling a vehicle transfer pallet to move the vehicle to a vehicle parking zone; and
controlling a second vehicle transfer robot to move the vehicle from the vehicle parking zone to one of a plurality of vehicle parking spaces in the vehicle parking zone.

16. The automated valet parking method of claim 15, wherein the controlling of the second vehicle transfer robot comprises, by a server, selecting the one of the plurality of vehicle parking spaces for parking the vehicle, and controlling the second vehicle transfer robot to move and park the vehicle to and at the selected one of the plurality of vehicle parking spaces.

17. The automated valet parking method of claim 15, further comprising, after the controlling of the second vehicle transfer robot, informing information on the selected one of the plurality of vehicle parking spaces where the vehicle is parked to the driver of the vehicle.

18. The automated valet parking method of claim 15, further comprising, after the controlling of the second vehicle transfer robot, by the second vehicle transfer robot, moving the vehicle from a first vehicle parking zone to a second vehicle parking zone,
wherein the first vehicle parking area is located such that the vehicle transport pallet moving along the vehicle transport rail arrives before the second vehicle parking area.

19. An automated valet vehicle pickup method comprising:
receiving information on a vehicle parked in a vehicle parking zone and a driver of the vehicle;
checking whether a vehicle corresponding to the information on the vehicle is parked in the vehicle parking zone;
by a first vehicle transfer robot, moving the vehicle parked in the vehicle parking zone to a vehicle transfer pallet configured to be movable along a vehicle transfer rail;
by the vehicle transfer pallet, transferring the vehicle moved to the vehicle transfer pallet to an area adjacent to a driver riding zone for picking up the vehicle by the driver; and
by a second vehicle transfer robot, moving the vehicle moved to the area adjacent to the driver riding zone to the driver riding zone so that the driver is allowed to pick up the vehicle.

20. The automated valet vehicle pickup method of claim 19, further comprising, after the moving of the vehicle moved to the area adjacent to the driver riding zone to the driver riding zone, notifying that pickup of the vehicle has been completed after the driver rides the vehicle moved to the driver riding zone.
